(19) United States
(12) Patent Application Publication
(10) Pub. No.: US 2014/0140629 A1
(43) Pub. Date: May 22, 2014

(54) METHODS FOR PROCESSING TARGET PATTERN, METHOD FOR GENERATING CLASSIFICATION SYSTEM OF TARGET PATTERNS AND METHOD FOR CLASSIFYING DETECTED TARGET PATTERNS

(71) Applicant: NATIONAL CHENG KUNG UNIVERSITY, Tainan City (TW)

(72) Inventors: Shen-Chuan TAI, Tainan City (TW); Wei-Ting TSAI, Taichung City (TW); Zih-Siou CHEN, Tainan City (TW)

(73) Assignee: NATIONAL CHENG KUNG UNIVERSITY, Tainan City (TW)

(21) Appl. No.: 13/782,374

(22) Filed: Mar. 1, 2013

(30) Foreign Application Priority Data
Nov. 21, 2012 (TW) 101143434

(51) Int. Cl. G06K 9/62

(52) U.S. Cl. CPC G06K 9/6267
USPC 382/218

(57) ABSTRACT

A method for processing a target pattern comprises the following steps: providing a to-be-processed image; matching the to-be-processed image is with a reference template to select at least one region of suspicion from the to-be-processed image, wherein the region suspicion comprises a target pattern and a background pattern; transforming the region of suspicion to a grayscale image; and transforming the grayscale image to an optical density image to enhance the target pattern with respect to the background pattern. A method for generating a classification system of target patterns and a method for classifying detected target patterns are also disclosed.

### CROSS REFERENCE TO RELATED APPLICATIONS

This Non-provisional application claims priority under 35 U.S.C. §119(a) on Patent Application No(s). 101143434 filed in Taiwan, Republic of China on Nov. 21, 2012, the entire contents of which are hereby incorporated by reference.

### BACKGROUND OF THE INVENTION

1. Field of Invention

This invention relates to a method for processing and enhancing a target pattern, a method for generating a classification of target patterns, and a method for classifying detected target patterns.

2. Related Art

As the need of the resolution and precision of the examination or detection increases, the technology of enhancing the difference between target patterns and background patterns in a to-be-processed image is more and more important. It also can be applied to other important fields, such as the medical field, to increase the difference of normal tissues and suspected abnormal tissues to help doctors with accurate diagnosis. On the other hand, the above technique can be applied to emphasize the defect existed on the surface of materials or wafers in order to increase the yield and contribute to the quality control.

However, the differences between target patterns and background patterns are still insufficient in the recent image processing technology. Therefore, it is difficult to figure out the target patterns within the to-be-processed image automatically and also difficult to distinguish the defects existed on the abnormal tissues, wafers or materials. Thus, finding a method for processing target patterns, method for generating a classification of target patterns and method for classifying detected target patterns becomes an important issue to lower the difficulties on distinguishing the defects existed on the abnormal tissues, wafers or materials.

### SUMMARY OF THE INVENTION

In view of the foregoing, an objective of the present invention is to provide a method for processing target patterns, method for generating a classification of target patterns and method for classifying detected target patterns. It can be applied for lowering the difficulties on distinguishing the defects existed on the abnormal tissues, wafers or materials by enhancing the difference between the target patterns and the background patterns. Furthermore, it can be combined with a plurality of training images to establish a classification system or method for automatically detecting.

To achieve the above objective, the present invention discloses a method for processing target pattern comprising the following steps of: providing a to-be-processed image; matching the to-be-processed image with a reference template to select at least a region of suspicion, wherein the region of suspicion comprises a target pattern and a background pattern; transforming the region of suspicion to a grayscale image; and transforming the grayscale image to an optical density image to enhance the target pattern with respect to the background pattern.

In one embodiment, the step of selecting the region of suspicion is performed by separating the region of suspicion from the to-be-processed image through a default frame.

In one embodiment, before the step of selecting the region of suspicion, the method further comprises the following step of: removing noises of the to-be-processed image by a filter.

In one embodiment, the reference template is a Sech template.

In one embodiment, the step of transforming the region of suspicion to the grayscale image is performed by transforming the target pattern of the region of suspicion.

In one embodiment, the step of transforming the grayscale image to the optical density image is performed according to a logarithm of a ratio of an incident light to a transmission light.

In one embodiment, the target pattern is an x-ray pattern of a target tissue.

To achieve the above objective, the present invention also discloses a method for generating a classification system of target patterns comprising the following steps of: providing a plurality of training images; matching each of the training images with a reference template to select regions of suspicion of the training images, wherein the regions of suspicion comprise a training target pattern and a training background pattern; transforming the regions of suspicion to a plurality of grayscale images; transforming the grayscale images to a plurality of optical density images; obtaining optical density texture features and discrete optical density features from each of the optical density images; and obtaining a combination selected from the optical texture features and the discrete optical features by a classifier to generate the classification system of the target patterns.

In one embodiment, the step of selecting the regions of suspicion is performed by separating the regions of suspicion from the training images through a default frame.

In one embodiment, before the step of selecting the regions of suspicion, the method further comprises the following step of removing noises of the training image by a filter.

In one embodiment, the reference template is a Sech template.

In one embodiment, the step of transforming the regions of suspicion to the grayscale images is performed by transforming the training target patterns of the regions of suspicion.

In one embodiment, the step of transforming the grayscale images to the optical density images is performed according to a logarithm of a ratio of an incident light to a transmission light.

In one embodiment, the target pattern is an x-ray pattern of a target tissue.

In one embodiment, the optical texture features are calculated by utilizing an optical density co-occurrence matrix algorithm.

In one embodiment, the combination comprises three of the optical density texture features and two of the discrete optical density features.

To achieve the above objective, the present invention further discloses a method for classifying detected target patterns comprising the following steps of: generating a classification system of target patterns; providing a detected image; matching the detected image with a reference template to select at least one detected region of suspicion of the detected image, wherein the detected region of suspicion comprise a detected target pattern and a detected background pattern; transforming the detected region of suspicion to a grayscale detected images; transforming the grayscale image to an optical density detected images; obtaining optical density texture features and discrete optical density features from the optical density detected images; and classifying the detected target pattern by utilizing a combination selected from the optical texture features and the discrete optical features through the classification system of the target patterns.

As mentioned above, a method for processing and enhancing a target pattern, method for generating a classification of target patterns and method for classifying detected target patterns are disclosed in the present invention to select the region of suspicion at first. The region of suspicion is then transformed through the grayscale image and the optical density image to emphasize the target pattern with respect to the background pattern. Therefore, the method will effectively assist doctors in the diagnosis of the abnormal tissues or detecting the defects existed on the wafer or material surface.

On the other hand, a classification system or method will be established after combining the training images for realizing automatic detection and avoiding the disadvantage in the prior art. That is, the prior disadvantage, such as the threshold representative of an abnormal status is unable to be established due to the smaller differences between the target pattern and the background pattern in the to-be-processed image, will be avoided by utilizing the method provided in the present invention.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is flow chart showing a method for processing a target pattern according to a preferred embodiment of the present invention;

FIG. 2a is diagram showing a to-be-processed image according to an embodiment of the present invention;

FIG. 2b is diagram showing the to-be-processed image after separating its foreground according to FIG. 2a;

FIG. 2c is diagram showing the to-be-processed image after removing pectoralis major muscle of muscle tissue according to FIG. 2b;

FIG. 2d is diagram showing the to-be-processed image after removing patterns of blood vessels and mammary gland tissues according to FIG. 2c;

FIG. 2e is diagram showing regions of suspicion obtained according to FIG. 2d;

FIG. 3a is diagram showing a target pattern within one of the regions of suspicion according to FIG. 2e before separating by a default frame;

FIG. 3b is diagram showing a target pattern within one of the regions of suspicion according to FIG. 2e after separating by a default frame;

FIG. 4 shows images before and after the step of transforming the grayscale image to an optical density image according to FIG. 3b;

FIG. 5 is flow chart showing a method for generating a classification of target patterns; and

FIG. 6a to FIG. 6d are diagrams showing results of classifying each of density detected images according to the method disclosed in the present invention.

### DETAILED DESCRIPTION OF THE INVENTION

The present invention will be apparent from the following detailed description, which proceeds with reference to the accompanying drawings, wherein the same references relate to the same elements.

The method for processing target patterns, the method for generating a classification of target patterns, and the method for classifying detected target patterns disclosed in the present invention can be applied to various fields that need detection and examination technique. For example, the quality management of manufacturing semiconductors, the analysis of the material surface, or the medical diagnosis. Furthermore, the invention can be applied to detect the defect of the wafer, the crack on steel surface, and the abnormal tissues of X-ray to-be-processed image. Hereafter, the detection of the breast cancer is taken as an embodiment in order to simplify the description but the present invention will not limit thereto.

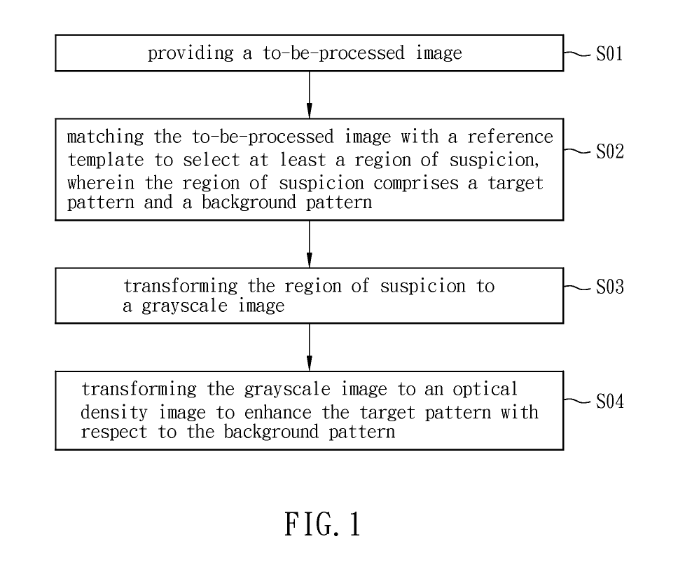

FIG. 1 is flow chart showing a method for processing a target pattern according to a preferred embodiment of the present invention. Referring to FIG. 1, the method for processing target patterns comprises steps S01 to S04.

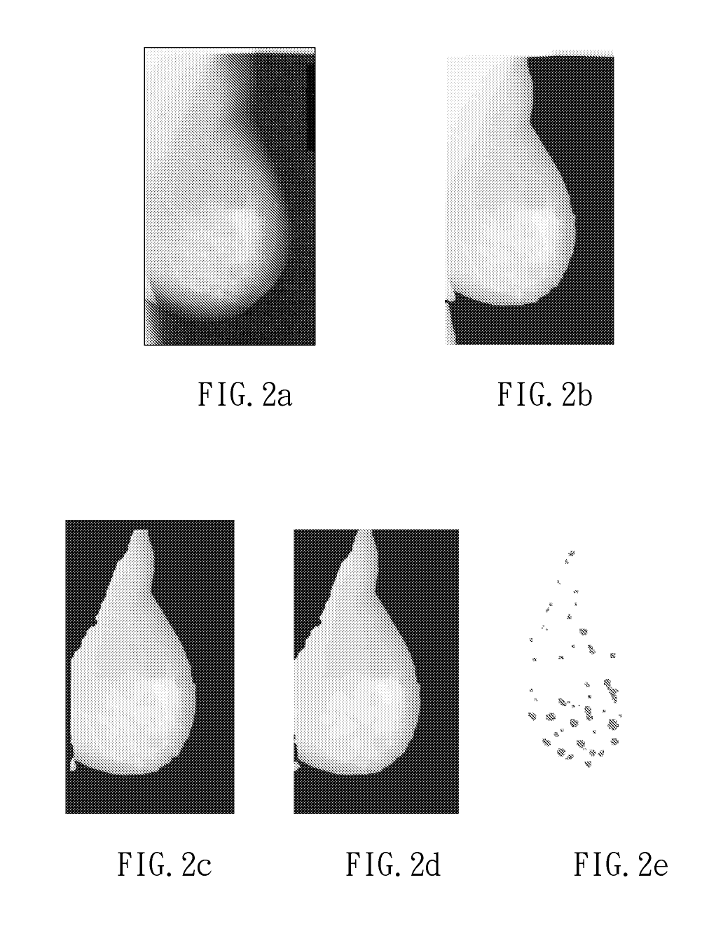

In step S01, a to-be-processed image is provided to be processed. In an embodiment, the to-be-processed image can be a mammogram. The photographic methods, such as cc view or MLO view taken toward the breast from 45 degrees from the outside of the breast (as shown in FIG. 2a), are usually understood by those who skilled in the art. Therefore the details or omitted here. FIG. 2a is diagram showing a to-be-processed image according to an embodiment of the present invention.

In step S02, the to-be-processed image is matched with a reference template to select at least one region of suspicion of the to-be-processed image, wherein the region of suspicion comprises a target pattern and a background pattern. The region of suspicion in the present embodiment, using the example of breast cancer, is to select a region, such as the abnormal tissue within the beast, as the target pattern, and the normal tissue is the background pattern.

The abnormal tissues, moreover, usually comprise masses or tumors. Because the physiological characteristics of them, they show a structure having a brighter central region in the to-be-processed image and darkening toward the surrounding region. Thus, the reference, which has a similar structure as above, will be chosen as a basis of comparison for effectively selecting the region of suspicion of the to-be-processed image. To be specific, the reference template can be a Sech template. The Sech template is a template of hyperbolic function, and its computing formula can be represented as the following:

$$S ( x , y ) = \frac{2}{exp ( β * \sqrt{{x}^{2} + {y}^{2}} ) + exp ( - β * \sqrt{{x}^{2} + {y}^{2}} )}$$

Actually, Sech template can adjust parameters by users, such as maximums of central brightness, minimums of surrounding brightness or gradients of the brightness from the central region to the surrounding region, to establish a filter standard for effectively selecting the region of suspicion, which may comprises the target pattern. On the other hand, the region of suspicion can be separated from the to-be-processed image through a frame after matching the to-be-processed image with the reference template for lowering the loading of process and memory. Furthermore, the default frame can select the regions of suspicion with different sizes according to the sizes of the target patterns by utilizing a segmentation template having self-adaptive function. Thus, there are a lot of square images, which are different but include a region of suspicion separately, obtained after adjusting the parameters of Sech template by users. Utilizing the abovementioned method of self-adaptive segmentation can broaden the application range, that is, the precision can be improved when the target pattern is detected and determined automatically in the future.

In addition, the method disclosed in the present invention further comprises the following steps before selecting the region of suspicion. First, s step of foreground extracting is performed to separate the foreground of the to-be-processed image as shown in FIG. 2b. And then, noises of the to-be-processed image can be removed by processing a filter. In the preferred embodiment, the filter can be a morphological filter, and it can be utilized to remove patterns of normal muscle tissues, such as pectoralis major muscle, blood vessels or mammary gland tissues to lowering the possibilities of error-detecting during the step of selecting the region of suspicion and speeding the operation of the system. Because the pattern of the muscle tissues, such as the pectoralis major muscle, are brighter, the filter can search and distinguish the position of the obviously difference between brightness and darkness so that the brighter patterns near the position will be removed by a triangular form. The to-be-processed image, which the pattern of the pectoralis major muscle has been removed, is shown as FIG. 2c. The patterns of the blood vessels and the mammary gland tissues are then removed, and the to-be-processed image is shown as FIG. 2d.

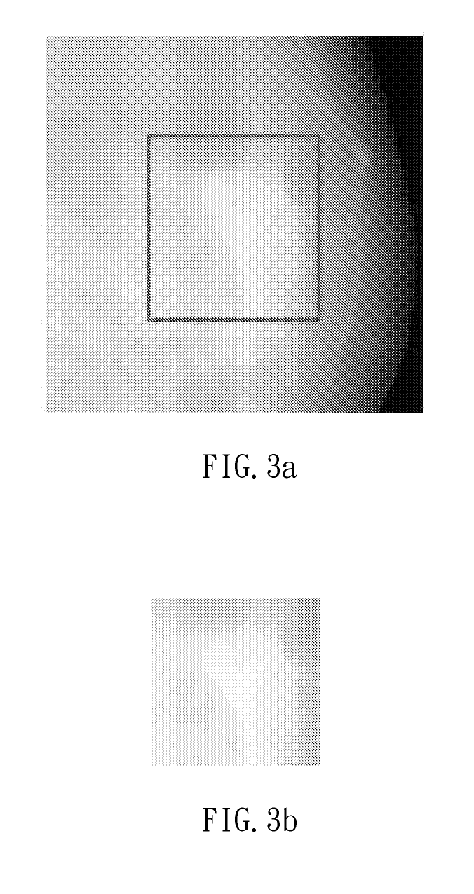

After removing the noises, the result of matching the to-be-processed image with the reference template is shown as FIG. 2e. And then, FIG. 3a and FIG. 3b are diagrams showing the target pattern within one of the regions of suspicion in FIG. 2e before and after separating by the default frame, wherein a solid linear frame with a square shape represents the size and the shape of the default frame. The inner part of the solid linear frame is the target pattern as shown in FIG. 3b, and the outer part of the solid linear frame is the background pattern.

The region of suspicion is transformed to a grayscale image in step S03, wherein the transformation of the grayscale image are usually understood by those who skilled in the art and will not be described herein in details.

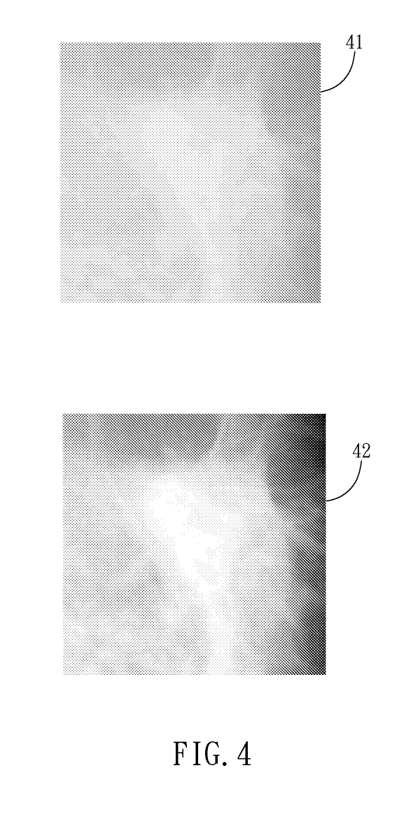

The grayscale image is transformed to an optical density image in step S04 to emphasize the target pattern with respect to the background pattern. In the preferred embodiment, the step S04 is performed according to a logarithm of a ratio of an incident light to a transmission light. That is, the grayscale image can be transformed through a transformation formula of the optical density to emphasize the region of the target pattern, such as the abnormal tissues or masses, to let the distinction between the target pattern and the background pattern increase, mammary gland tissues especially. As shown in FIG. 4, the image 41 is the grayscale image transformed from the region of suspicion, and the image 42 is the optical density image transformed from the grayscale image.

The abovementioned transformation formula of the optical density are understood by those who skilled in the art and represented as the following:

$${OD}_{ij} = log ( \frac{{I}_{ij}}{{I}_{o}} )$$

As shown in the formula as above, ODᵢⱼ is an optical density of a pixel (i, j), Iᵢⱼ is luminous intensity of the pixel (i, j) of the target pattern in the grayscale image, i and j are integers, I₀ is transmission light and can be the maximal, minimal or average luminous intensity of the background pattern. The transformed optical densities are linearly corresponded to a value of 0 to 255 to obtain an optical density image, wherein the minimal optical density corresponds to 0 and the maximal optical density corresponds to 255.

The target pattern of the region of suspicion, such as the abnormal tissues of the mammogram according to preferred embodiment, can be clearly emphasized from the to-be-processed image through the above method. Especially when the subject of mammogram is an Asian woman, her breast usually has very high breast density. Due to the complicate textural background patterns of the to-be-processed image with high breast density, the abnormal tissues could be covered by the mammary gland tissues so that it is difficult to distinguish whether the abnormal tissue exists or not. However, the method provided in the present invention for processing and enhancing the target patterns can effectively emphasize the abnormal tissues for further diagnosis.

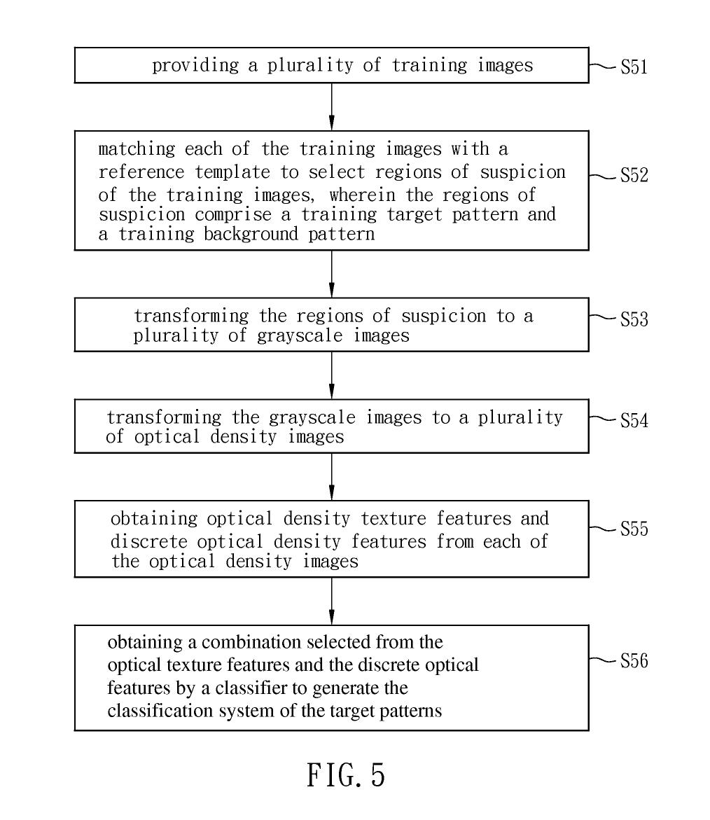

FIG. 5 is flow chart showing a method for generating a classification of target patterns. Referring to FIG. 5, a method for generating a classification of target patterns comprises steps S51 to S56.

As shown in step S51, pluralities of training images are provided, and they are a plurality of mammograms. The purpose of utilizing the training images is to establish a classification system through their different significances of classification with respect to the target patterns. The significance of classification means that there is a portion of target patterns in the training images representative of the abnormal tissues, and there are another portion of target patterns in the training images representative of the normal tissues.

The steps S51 to S54 are similar to the steps S01 to S04 as abovementioned embodiment. The other steps performed between the steps S01˜S04 are also suitable for using in the present embodiment. That is, the training images correspond to the to-be-processed image, and the training target patterns and the training background patterns correspond to the target pattern and the background pattern. However, the training images can be processed separately or simultaneously.

In step S55, several optical density features of are obtained from each of the optical density images. In the present embodiment, the optical density features comprise optical density texture features and discrete optical density features. The optical density texture features are obtained from an optical density co-occurrence matrix algorithm, that is, the relation of the optical density between two pixels of the optical density image can be obtained by defining the angle and distance. Actually, there are four different angles (0°, 45°, 90° and 135°) defined in the present embodiment for calculating the optical density features. For example, fourteen feature-based models are defined by Haralick, and four co-occurrence matrixes are used to obtain fifty-six optical density texture features of the co-occurrence matrix. As to other details of the co-occurrence matrix algorithm are usually understood by those who skilled in the art. The discrete optical density features can be thirteen feature-based models defined by Sameti, however, the method for obtaining them are usually understood by those who skilled in the art and will not be described in details hereafter.

In step S56, a classification system of the target patterns is obtained by a combination selected from the optical texture features and the discrete optical features through a classifier.

The classifier, which is established according to a stepwise discriminate analysis, regards the obtained optical density images as a training set and further analyzes the features with the significance of classification according to sixty-nine features of each of the optical density images (including fifty-six optical density texture features and thirteen discrete optical density features) to form the combination and generate a linear discriminant function, that is, the classification of target patterns. Preferably, the combination comprises three of the optical density texture features and two of the discrete optical density features.

After establishing the abovementioned classification system of the target patterns, the detected images obtained in the following steps can be classified through the system to automatically determine whether an abnormal tissue or a surface defect exists or not.

The present invention further provides a method for classifying detected target patterns. The method is performed to classify the target pattern within the detected image by utilizing the above classification system to determine if an abnormal tissue or a surface defect exists in the detected image or not.

The actual processes refer to the steps S01˜S04 as shown in FIG. 1, that is, the detected image is transformed to an optical density detected image wherein the to-be-processed image comprises a detected target pattern and a detected background pattern. And then, the step S55 as shown in the above embodiment and FIG. 5 to calculate the optical density texture features and discrete optical density features to obtain the combination.

And then, it is performed to compare the combination of parameters used in the classification system and select the same parameters of the combination to further process a linear discriminant Analysis. As mentioned above, the detected target pattern can be classified and determined whether it is interesting or not, such as an abnormal tissue or surface defect. On the other hand, the combination of parameters can be changed to adjust the classification standard to broaden or narrow the region of interesting.

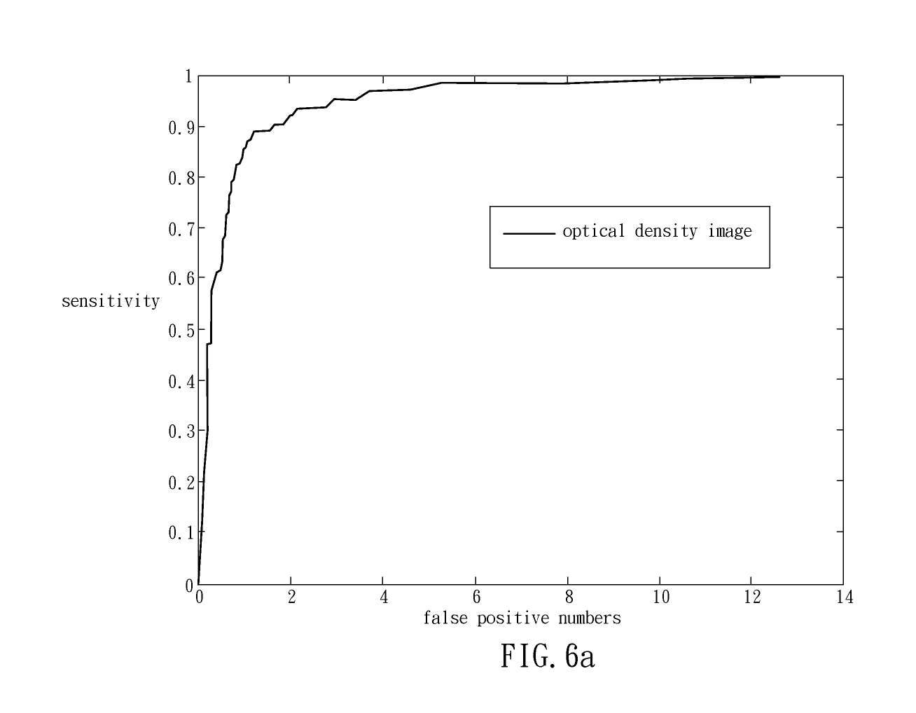

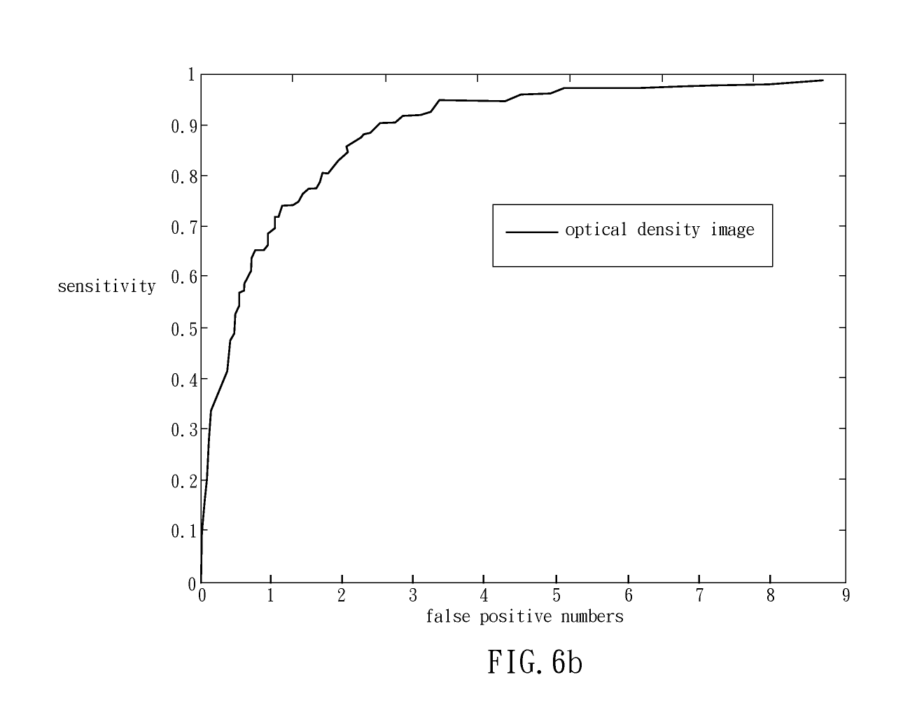

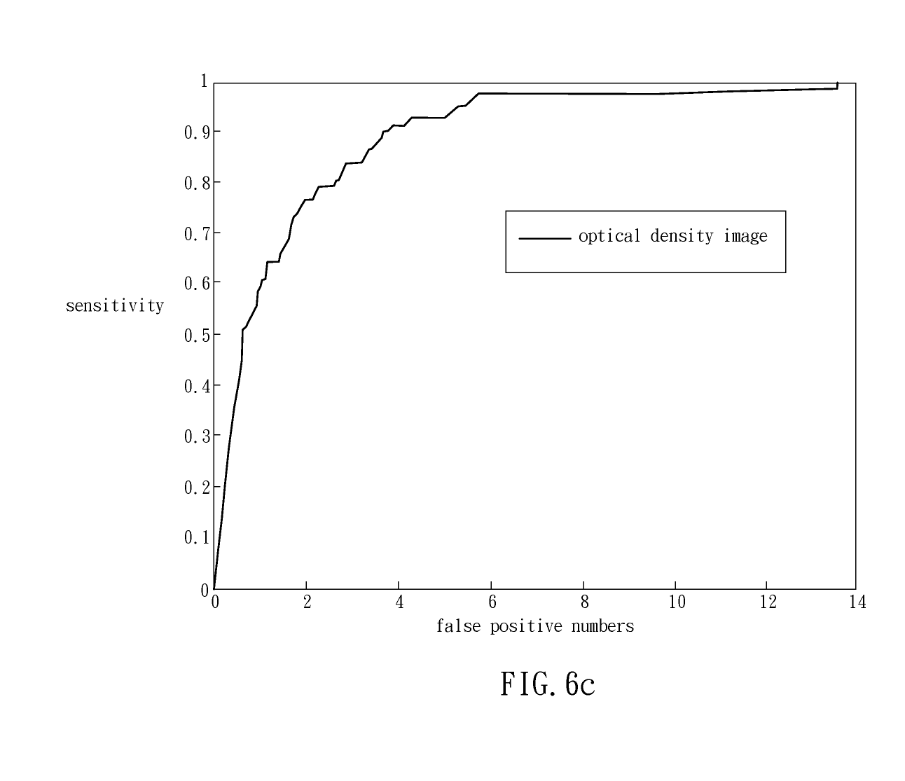

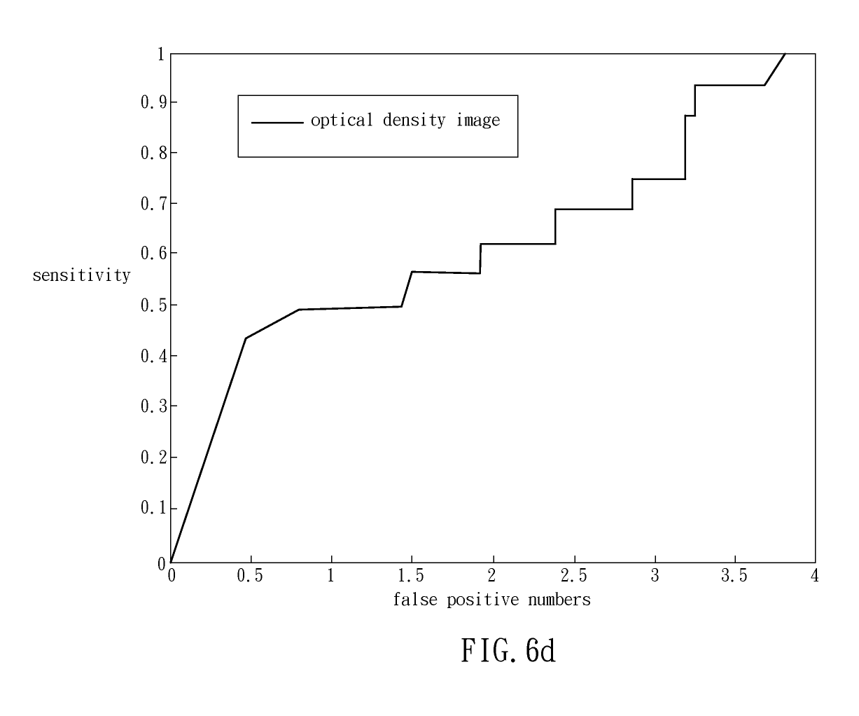

In an embodiment, 358 cases containing 180 malignant tumors, 128 benign tumors and 50 normal cases from the Digital Database of south Florida for Screening Mammography is conducted. The breast density can be divided into four levels, and the breast density increase progressively from level 1 to level four. The breast of level 1 means that is a very fatty breast and easy for distinguishing by eyes. On the contrary, the breast density of level 4 means that is almost composed of mammary gland tissues, and the textures of its detected image are much complicated so that the mass therein is difficult to be distinguished. FIG. 6a to FIG. 6d are diagrams showing results of classifying each of density detected images according to the method disclosed in the present invention.

As shown in the figures, the horizontal axis indicates false positive numbers existed in each of the detected images, and the vertical axis indicates the sensitivity of the method disclosed in the present invention. In general, the method is better when the sensitivity is higher and the false positive numbers is lower. It is obviously that the false positive numbers is 3 as the sensitivity is 88.1% in mammographic density 3 and the false positive numbers is 3.2 as the sensitivity is 88.9% in mammographic density 4.

To sum up, a method for processing and enhancing a target pattern, method for generating a classification of target patterns and method for classifying detected target patterns are disclosed in the present invention to select the region of suspicion at first. The region of suspicion is then transformed through the grayscale image and the optical density image to emphasize the target pattern with respect to the background pattern. Therefore, the method will effectively assist doctors in the diagnosis of the abnormal tissues or detecting the defects existed on the wafer or material surface.

On the other hand, a classification system or method will be established after combining the training images for realizing automatic detection and avoiding the disadvantage in the prior art. That is, the prior disadvantage, such as the threshold representative of an abnormal status is unable to be established due to the smaller differences between the target pattern and the background pattern in the to-be-processed image, will be avoided by utilizing the method provided in the present invention.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A method for processing target pattern comprising the following steps:
providing a to-be-processed image;
matching the to-be-processed image with a reference template to select at least a region of suspicion, wherein the region of suspicion comprises a target pattern and a background pattern;
transforming the region of suspicion to a grayscale image; and
transforming the grayscale image to an optical density image to enhance the target pattern with respect to the background pattern.

2. The method according to claim 1, wherein the step of selecting the region of suspicion is performed by separating the region of suspicion from the to-be-processed image through a default frame.

3. The method according to claim 1 further comprising the following step before the step of selecting the region of suspicion:
removing noises of the to-be-processed image by a filter.

4. The method according to claim 1, wherein the reference template is a Sech template.

5. The method according to claim 1, wherein the step of transforming the region of suspicion to the grayscale image is performed by transforming the target pattern of the region of suspicion.

6. The method according to claim 1, wherein the step of transforming the grayscale image to the optical density image is performed according to a logarithm of a ratio of an incident light to a transmission light.

7. The method according to claim 1, wherein the target pattern is an x-ray pattern of a target tissue.

8. A method for generating a classification system of target patterns comprising the following steps:
providing a plurality of training images;
matching each of the training images with a reference template to select regions of suspicion of the training images, wherein the regions of suspicion comprise a training target pattern and a training background pattern;
transforming the regions of suspicion to a plurality of grayscale images;
transforming the grayscale images to a plurality of optical density images;
obtaining optical density texture features and discrete optical density features from each of the optical density images; and
obtaining a combination selected from the optical texture features and the discrete optical features by a classifier to generate the classification system of the target patterns.

9. The method according to claim 8, wherein the step of selecting the regions of suspicion is performed by separating the regions of suspicion from the training images through a default frame.

10. The method according to claim 8 further comprising the following step before the step of selecting the regions of suspicion:
removing noises of the training image by a filter.

11. The method according to claim 8, wherein the reference template is a Sech template.

12. The method according to claim 8, wherein the step of transforming the regions of suspicion to the grayscale images is performed by transforming the training target patterns of the regions of suspicion.

13. The method according to claim 8, wherein the step of transforming the grayscale images to the optical density images is performed according to a logarithm of a ratio of an incident light to a transmission light.

14. The method according to claim 8, wherein the target pattern is an x-ray pattern of a target tissue.

15. The method according to claim 8, wherein the optical texture features are calculated by utilizing an optical density co-occurrence matrix algorithm.

16. The method according to claim 8, wherein the combination comprises three of the optical density texture features and two of the discrete optical density features.

17. A method for classifying detected target patterns comprising the following steps:
generating a classification system of target patterns according to claim 8;
providing a detected image;
matching the detected image with a reference template to select at least one detected region of suspicion of the detected image, wherein the detected region of suspicion comprise a detected target pattern and a detected background pattern;
transforming the detected region of suspicion to a grayscale detected images;
transforming the grayscale image to an optical density detected images;
obtaining optical density texture features and discrete optical density features from the optical density detected images; and
classifying the detected target pattern by utilizing a combination selected from the optical texture features and the discrete optical features through the classification system of the target patterns.
